(19) United States
(12) Patent Application Publication
(10) Pub. No.: US 2025/0073969 A1
(43) Pub. Date: Mar. 6, 2025

(54) CAP TOOL WITH LOAD CELL

(71) Applicant: ENCORE AUTOMATION, LLC, Auburn Hills, MI (US)

(72) Inventor: Cameron J. MOORE, Bloomfield Hills, MI (US)

(73) Assignee: Encore Automation, LLC, Auburn Hills, MI (US)

(21) Appl. No.: 18/548,012

(22) PCT Filed: Mar. 28, 2023
(86) PCT No.: PCT/US2023/016499

§ 371 Date: Aug. 25, 2023

Related U.S. Application Data
(60) Provisional application No. 63/337,342, filed on May 2, 2022.

(51) Int. Cl. B29C 45/14; B29C 45/76; B29K 81/00; B29L 31/00

(52) U.S. Cl. CPC B29C 45/14336; B29C 2045/14459; B29C 45/7613; B29C 2945/76013; B29C 2945/76314; B29C 2945/76481; B29C 2945/76545; B29C 2945/76859; B29K 2081/00; B29L 2031/727

(57) ABSTRACT

A fastener sealing tool that utilizes curable material to seal the area around a fastener connected to a surface. In one embodiment of the invention the fastener sealing tool is a manually operated tool, hand operated by a user who visually identifies the fastener to be sealed and then operates the fastener sealing tool to seal the desired fastener. In a second embodiment of the invention the fastener sealing tool is an end of arm tool for a robot that automatically identifies or is programmed to move to the location of the fastener, and then seal the fastener using the fastener sealing tool. The fastener sealing tool utilizes a load cell to control the flow of material and to detect certain unwanted conditions.

### FIELD OF THE INVENTION

The present invention relates to a fastener sealing tool and method for sealing fasteners from the outside environment.

### SUMMARY OF THE INVENTION

A first embodiment of the invention is directed to a fastener sealing tool having a tool body having a fixed mount and a pivot arm pivotally connected to the fixed mount at a pivot connection. A mold connected to the pivot arm of the tool body, where the mold is shaped to be placed over a fastener connected to a surface. A resin injection passage extending through the tool body and connected to the mold, wherein a curable material selectively flows through the resin injection passage into the mold. The fastener sealing tool further includes a load cell connected to the fixed mount. The load cell is a sensor operably connected to the pivot arm that senses movement of the pivot arm about the pivot connection. The load cell assists with determining when an undesirable event has occurred. An undesirable event includes, but is not limited to, over filling of the mold, misalignment of the mold or an obstruction collision. The fastener sealing tool according to this embodiment of the invention is connected to a robotic arm or can be a manually operated tool that is hand operated by a user.

A second embodiment of the invention is directed to a fastener sealing tool that utilizes ultraviolet (UV) light curable material to seal the area around a fastener connected to a surface. The fastener sealing tool has a translucent mold and UV light source that shines UV light through the translucent mold to cure the UV curable material. In one embodiment of the invention the fastener sealing tool is a manually operated tool, hand operated by a user who visually identifies the fastener to be sealed and then operates the fastener sealing tool to seal the desired fastener. In a second embodiment of the invention the fastener sealing tool is an end of arm tool for a robot that automatically identifies or is programmed to move to the location of the fastener, and then seal the fastener using the fastener sealing tool.

In the second embodiment of the invention described above the fastener sealing tool includes a translucent mold connected to an end of a tool body that is placed over a fastener connected to a surface. A resin injection passage extends through the tool body and is connected to the translucent mold, wherein an ultraviolet light curable material flows through the resin injection passage into the translucent mold. An ultraviolet light source is connected to the tool body and is configured to project ultraviolet light through the mold to cure the UV curable material that fills the translucent mold, thereby sealing the area around where the fastener connects to the surface.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic diagram of a fastener sealing tool and the method of sealing a fastener connected to a surface.

FIG. 2 is a flow chart of the method of sealing a fastener connected to a surface.

FIG. 3 is a bottom side perspective view of a fastener sealing tool according to a first embodiment of the invention.

FIG. 4 is a side cross sectional view of the fastener sealing tool according to the first embodiment of the invention.

FIG. 5 is a side elevational view of the fastener sealing tool.

FIG. 6 is a schematic diagram of a portion of the fastener sealing tool and a method of sealing a fastener connected to a surface, where the method and fastener sealing tool have cap overflow detection.

FIG. 7 is a side cross-sectional view of the valve which controls the flow of resin into the injection port of the mold.

### DETAILED DESCRIPTION OF THE PREFERRED EMBODIMENTS

The following description of the preferred embodiments are merely exemplary in nature and is in no way intended to limit the invention, its application, or uses.

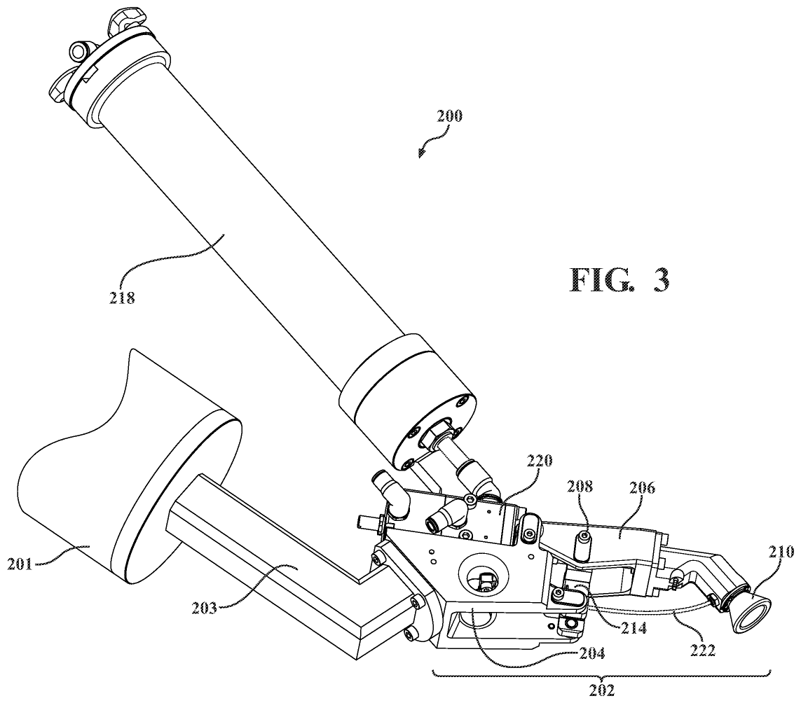

Referring now to FIG. 3-5, show a fastener sealing tool 200 that is able to be connected to a robotic arm 201. Alternatively, the fastener sealing tool 200 can be modified to have a handle for being operated by a human. The fastener sealing tool has a tool body 202 with a fixed mount 204. The fixed mount 204 is connectable a fitting 203 that is connectable to the robotic arm 201. The tool body 202 further includes a pivot arm 206 pivotally connected to the fixed mount 204 at a pivot connection 208. Pivot connection 208 is any type of hinged connection that allows the pivot arm 206 to pivot about the pivot connection 208 relative to the fixed mount 204. In the present embodiment the pivot connection 208 is a pin and bushing or roller bearing, a screw with a nut or a leaf with a pin.

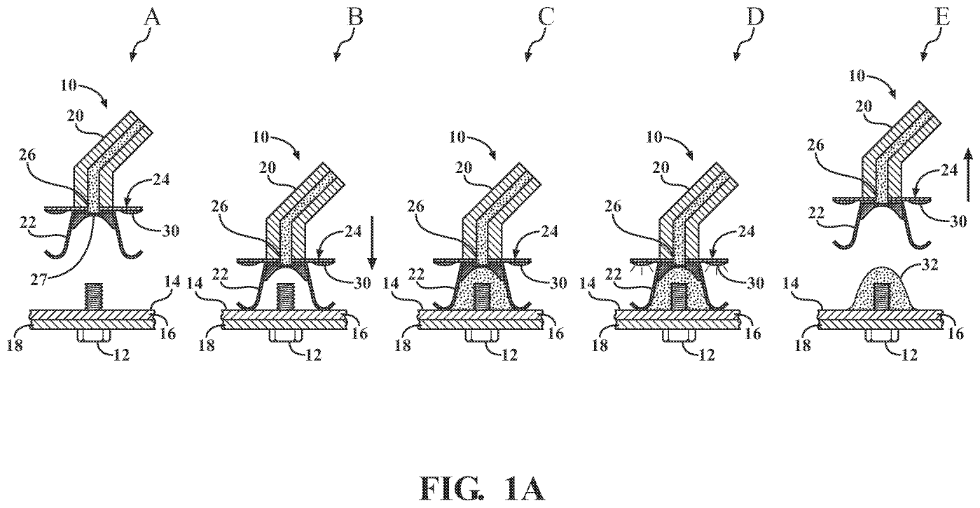

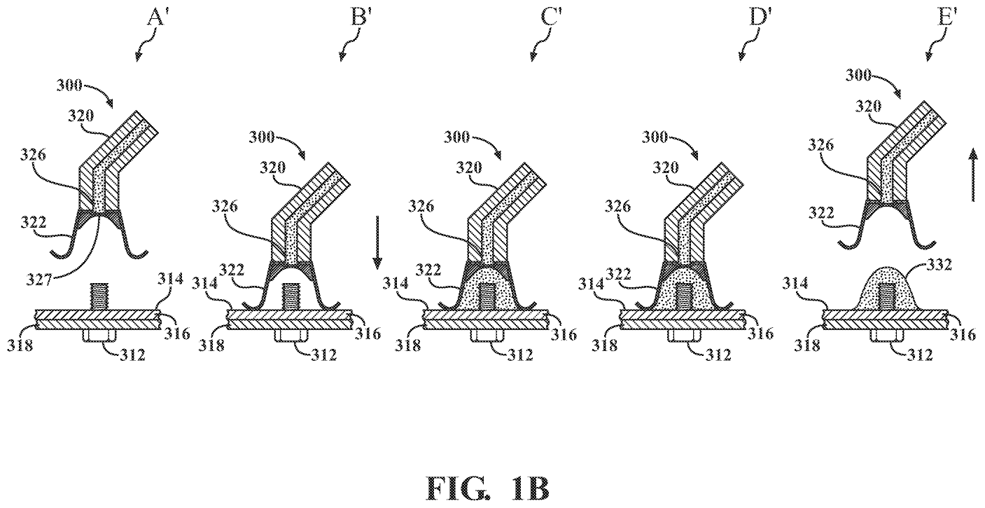

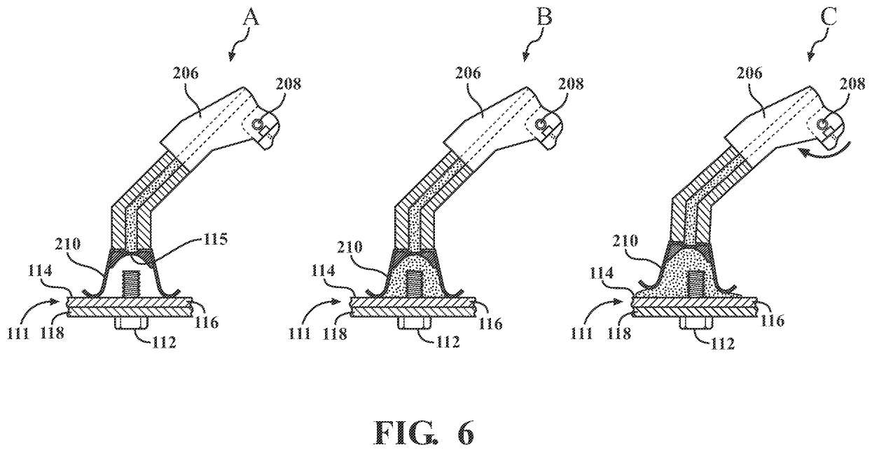

Pivot connection 208 is at or near one end of the pivot arm 206. At a second end of the pivot arm 206 there is a mold 210. The mold 210 is shaped to be placed over a fastener 12, 112 (shown in FIGS. 1 and 6) connected to a surface. The mold 210 covers an area of the surface adjacent the fastener 12, 112. A resin injection passage is formed on an inside surface of the mold 210 to allow curable material to selectively flow through the resin injection passage into the translucent mold. In the embodiment shown in FIGS. 3-5 the curable material is not UV curable and the mold 210 is not translucent and is opaque. The curable material is generally a polysulfide sealant, but more specifically a polysulfide aerospace sealant. In some embodiments the curable material is an ultraviolet (UV) light curable material and the mold 210 is translucent to allow UV rays from a UV light source to pass through the mold 210 and cure the curable material. While specific curable materials are described above, the present invention is not necessarily limited to one specific type of curable material, since there are several curable materials that can be used.

Connected to the fixed mount 204, between the pivot arm 206 and the fixed mount 204, is a load cell 214 that is a sensor consisting of strain gauges that are wired together to determine the amount of strain or force on the pivot arm. The load cell 214 sends a signal to a controller that corresponds to the amount of movement of the pivot arm 206 about the pivot connection 208 with the fixed mount 204. While the present invention describes a load cell, it is within the scope of the invention for the load cell 214 to be replaced with a different type of device or sensor suitable to detect displacement of the pivot arm 206 that provides consistent volume commands from the controller regardless of any variances in viscosity, rheology, compressibility, etc. Other examples of suitable sensors include but are not limited to torque sensors and displacement sensors. In the embodiment shown, the load cell 214 has a button that physically contacts and is depressed by the pivot arm 206. When certain events occur, the pivot arm 206 moves away from the load cell 214 and the button becomes undepressed. The load cell 214 provides an analog signal to the controller and is sensitive enough that the signal value changes depending on the amount of movement of the pivot arm 206. This allows for data from the load cell 214 to be interpreted in different ways, for example an overflow event could be distinguished from a misalignment event.

Referring now to FIG. 6, an example of an overflow event is shown. At step A the mold 210 on the pivot arm 206 is positioned over a fastener 112 and contacts a surface 114 of a workpiece 111. The fastener 112 is extending through and is used to connect a first piece 116 and a second piece 118 together. At a step B the mold 210 is filled with a curable material 113 that flows through an inlet 115 that is connected to a passage 117 in the pivot arm 206. The resin in this embodiment is a non-UV curable resin. One example is a polysulfide aerospace sealant. The resin can be any one component or two component sealant (that would be mixed upstream). At a step C an overflow event has occurred where the cavity in the mold 210 overflows with the resin 113, which causes the pivot arm 206 to rotate about the pivot 208, disengaging the pivot arm 206 from the load cell 214.

At step C the load cell 214 will generate a certain signal that suggest movement or overflowing the mold 210. The controller can then issue an alert that an overflow condition might exist and instruct the fastener sealing tool 200 to stop the flow of curable material to the mold 210, which can be accomplished by the controller turning off a valve 220, the operation of which is described in greater detail below. Other conditions that can be sensed include, but are not limited to, inadequate part alignment if load cell 214 senses an unexpected bump of the mold 210 and the part, air bubbles in the resin, uncured resin or any other anomaly that can be detected by using data from the load cell 214 concerning the movement of the pivot arm 206. Also, the data from the load cell 214 can be combined with other data or information. For example, a controller can determine what kind of event has occurred by analyzing the data from the load cell 214 and the operational step that is occurring.

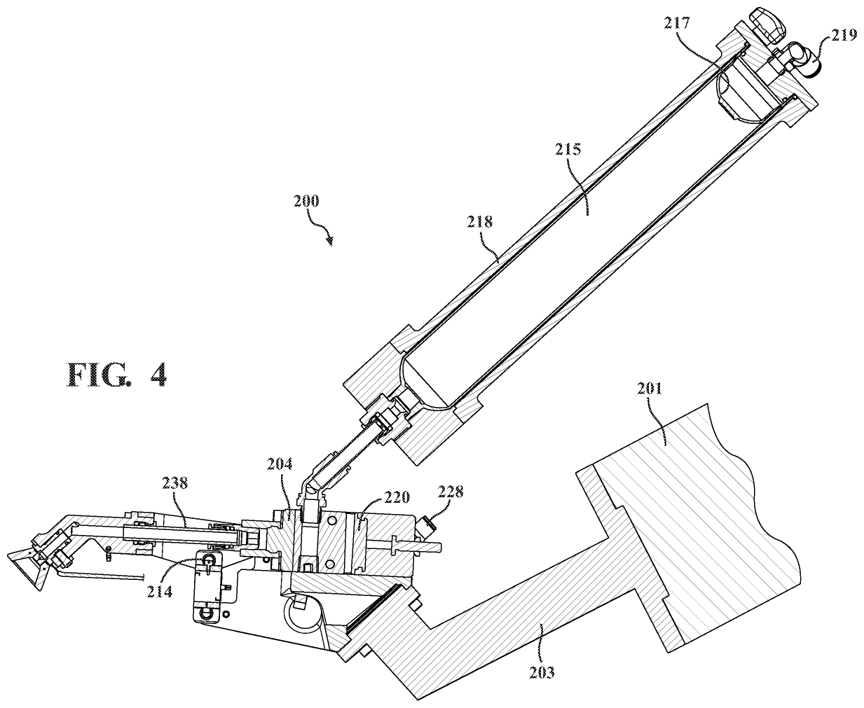

Referring back to FIGS. 3-5, the fastener sealing tool 200 further includes a resin supply tank 218 connected to the fixed mount 204. The resin supply tank 218 is optional and can be replaced with a resin supply line that supplies resin from a supply tank remove from the fastener sealing tool 200. The resin supply tank 218 can be filled directly with curable material or as shown in FIG. 4 a resin cartridge 215 pre-loaded with curable material is loaded into the resin supply tank 218. The resin cartridge 215 includes a plunger 217 that applies pressure and moves longitudinally along the length of the resin cartridge 215. The resin cartridge 215 applies pressure to the curable material in the resin cartridge 215 to cause the curable material to flow out of an outlet of the resin supply tank 218.

In certain applications pressure greater than 90 psi is needed to dispense curable material from the resin supply tank. In order to maintain adequate pressure by the plunger 217 a pressure booster 225 is connected by an air line 224 to an air supply inlet 219 on the resin supply tank 218. The pressure booster 225 provides pressurized air at a predetermined pressure value (e.g., greater than 90 psi), which in turn acts on the plunger 217 and applies a desired force on the curable material in the resin cartridge 215, thereby causing a desired flow of curable material from the outlet of the resin cartridge 215 and the resin supply tank 218. The pressure booster 225 is shown mounted to the robotic arm, however, it is within the scope of the invention for the pressure booter 225 to be mounted anywhere. As suggested above, the pressure booster 225 is an optional component that might not be necessary in every application.

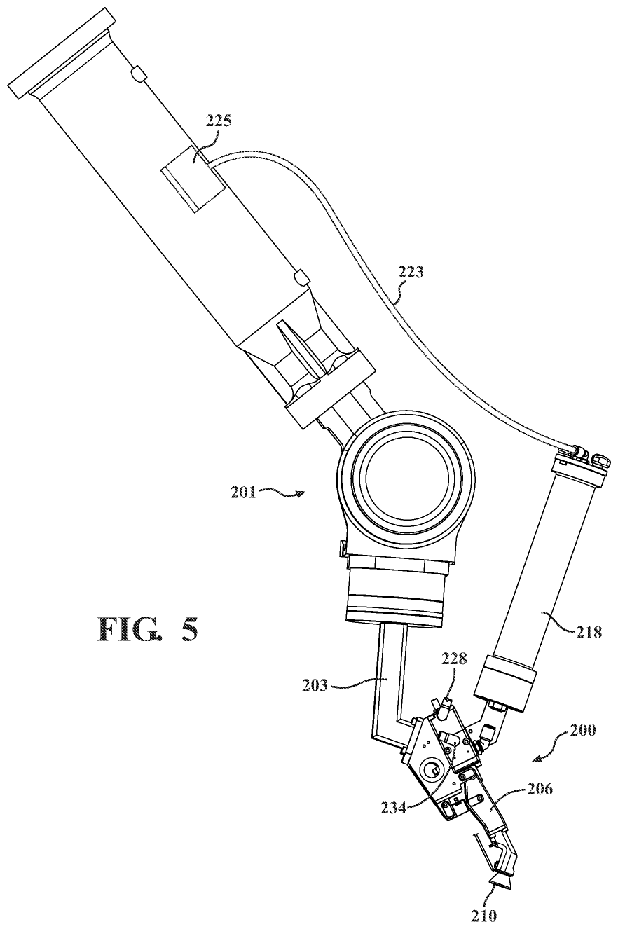

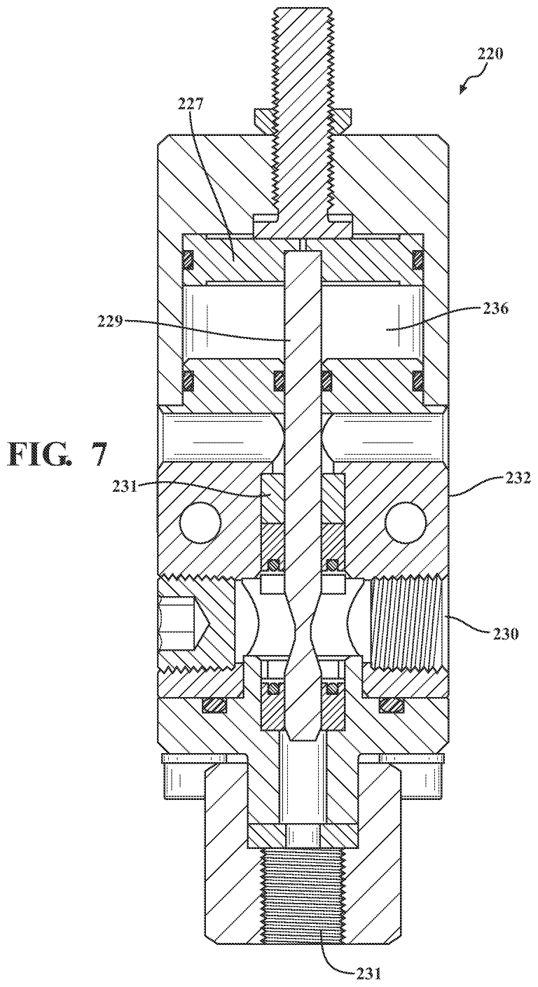

The valve 220 is connected to the fixed mount 204 and the resin supply tank 218. The valve 220 can be any type of valve suitable for controlling the flow of resin from the resin supply tank 218 to the injection port of the mold 210. Referring now to FIG. 7, the details of the valve 220 are shown. Valve 220 includes a spool 229 that is connected to a plunger 227. There is an air inlet open port 228 (shown in FIGS. 4 and 5) that applies air above the plunger 227 to move the spool 229 downward to allow the curable material to flow through the valve 220 from a resin inlet 230 to a resin outlet 231, both formed through a body 232 of the valve 220. An air inlet close port 234 (shown in FIG. 5) that introduces air to a region 236 in the valve 220 that applies pressure to the plunger 227 in the opposite direction to move the spool 229 upward from the open position to the closed position. The resin outlet 231 of the valve 220 connects to a supply line 238 extending between the mold 210 and the valve 220 for flowing resin between the valve 220 and the mold 210. The supply line 238 supplies resin to the resin injection passage 326 described above.

FIG. 1A depicts a schematic diagram of a fastener sealing tool 10 and method of sealing a fastener 12 connected to a surface 14. The fastener 12 as shown connects a first piece 16 and a second piece 18 together. The first piece 16 has the surface 14 that is exposed and benefits from being sealed. The sealing protects the fastener 12, first piece 16 and second piece 18 from the intrusion of water, air, or other unwanted fluids. In one embodiment of the invention the fastener is a type of fastener used on aircraft bodies and the first piece and the second piece are portions of an aircraft, however, it is within the scope of this invention for sealed fasteners to be used in other applications and is not necessarily limited to the field of aeronautics but includes applications in virtually any other field including but not limited to marine, automotive and the electronics field.

The fastener sealing tool 10 as shown is similar to the fastener sealing tool 200 shown in FIGS. 3-5. The fastener sealing tool 10 includes a tool body 20 that can be connected to a robotic arm for an automated method of operation, or it can be a hand held tool used for manual operation. As shown in Step A and Step B a translucent mold 22 is connected to an end 24 of the tool body 20 and is placed over the fastener 12 connected to the surface 14. A resin injection passage 26 extends through the tool body 20 and is connected to the translucent mold 22, wherein an ultraviolet (UV) curable material 28 flows through the resin injection passage 26 into the translucent mold 22, as shown at step C. The resin injection passage 26 terminates at a valve 27, which is a silicone valve, however, it is within the scope of the invention for the valve to be any type of valve suitable for controlling the flow of curable material in the translucent mold 22. At step C the UV curable material 28 flows into the translucent mold 22. At step D an ultraviolet light source 30, which is connected to the tool body 20 and is configured to project ultraviolet light through the translucent mold 22, is activated to cure the UV curable material 28 that fills the translucent mold 22, thereby sealing the area around where the fastener 12 connects to the surface 14. At a step E the tool body 20 is moved away from the surface 14 and a cured adhesive dome 32 is left that encapsulates the exposed portion of the fastener 12.

The present invention also contemplates implementing a release mechanism connected to the translucent mold 22, for assisting in removing the translucent mold from the cured resin. The release mechanism can take many forms including, but not limited to compressed air ports connected to the translucent mold 22, coating material on the inside surface of the translucent mold, as well as mechanical features such as push pins.

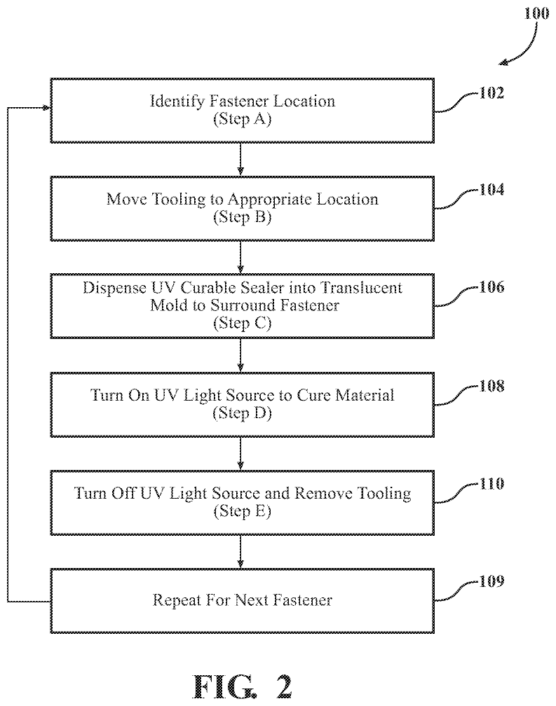

Referring now to FIGS. 1A and 2 a method 100 of sealing the fastener 12 is shown and described. The method 100 includes providing the fastener sealing tool 10 having the tool body 20 with the translucent mold 22 being connected to the tool body 20. The method also includes providing the resin injection passage 26 extending through the tool body 20 and connected to the translucent mold 22. Further provided is the ultraviolet light curable material 28 that selectively flows through the resin injection passage 26 into the translucent mold 22. Also provided is the ultraviolet light source 30 connected to the tool body 20 and configured to project ultraviolet light toward the translucent mold 22.

At a step 102 identifying the location of the location of the fastener 12 to be sealed is carried out. In a manually operated embodiment this is accomplished by a user visually locating the fastener 12. In an automated embodiment using a robot step 102 can be accomplished by using different cameras to identify the location of the fastener or by training the robot to learn the location of the fastener on the workpiece. The types of cameras include digital, infrared, or other types of cameras suitable for identifying the fastener location.

Step 104 includes moving the tool body 20 to the location of the fastener 12 and placing the translucent mold 22 in contact with the surface 14 adjacent to the fastener 12 to be sealed. Then at a step 106 the method further includes dispensing the ultraviolet light curable material 28 through the resin injection passage 26 into the translucent mold 22. The ultraviolet material is a type of polymeric resin or adhesive that is cured using ultraviolet light. At a step 108 the ultraviolet light source 30 is activated and projects ultraviolet light through the translucent mold 22 and cures the ultraviolet light curable material 28.

At a step 110 the ultraviolet light source 30 is deactivated and the fastener sealing tool 10 is moved away from the fastener 12 and the surface 14 leaving the fastener 12 encapsulated in cured material 32. At a step 109 the method 100 moves onto the next fastener and repeats starting with step 102. An additional optional step includes the use of a camera mounted to the robotic arm or at a location near the work piece that performs an inspection of the cured material to make sure the fastener 12 has been properly sealed. The camera can also include a laser that is able to inspect the surface 14 by projecting a beam onto the surface 14 to detect gaps or other flaws in the cured material 31. In another embodiment of the invention the method 100 us modified to utilize an adhesive material that is not activated by UV light. The fastener sealing tool 200 can be used with any type of adhesive and the method 100 described above would exclude any steps that require using UV light to cure the material. Another example of material that can be used with the fastener sealing tool 200 is a polysulfide aerospace sealant.

FIG. 1B depicts a schematic diagram of the fastener sealing tool 300, and method of sealing a fastener 312 connected to a surface 314. The fastener sealing tool 300 is identical to the fastener sealing tool 200 described above. The fastener 312 as shown connects a first piece 316 and a second piece 318 together. The first piece 316 has the surface 314 that is exposed and benefits from being sealed. The sealing protects the fastener 312, first piece 316 and second piece 318 from the intrusion of water, air, or other unwanted fluids. In one embodiment of the invention the fastener is a type of fastener used on aircraft bodies and the first piece and the second piece are portions of an aircraft, however, it is within the scope of this invention for sealed fasteners to be used in other applications and is not necessarily limited to the field of aeronautics but includes applications in virtually any other field including but not limited to marine, automotive and the electronics field.

The fastener sealing tool 300 includes a tool body 320 that can be connected to a robotic arm for an automated method of operation, or it can be a hand held tool used for manual operation. As shown in Step A and Step B a mold 322, which can be opaque, is connected to an end 324 of the tool body 320 and is placed over the fastener 312 connected to the surface 314. A resin injection passage 326 extends through the tool body 320 and is connected to the mold 322, wherein a curable material 328 flows through the resin injection passage 326 into the mold 322, as shown at step C. The resin injection passage 326 terminates at a valve 327, which is a silicone valve, however, it is within the scope of the invention for the valve to be any type of valve suitable for controlling the flow of curable material in the mold 322. At step C the curable material 328 is flowed into the mold 322. At step D the mold 322 is held in position for a period of time while the curable material 328 cures, thereby sealing the area around where the fastener 312 connects to the surface 314. At a step E the tool body 320 is moved away from the surface 314 and a cured adhesive dome 332 is left that encapsulates the exposed portion of the fastener 312.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fastener sealing tool comprising:
a tool body having a fixed mount and a pivot arm pivotally connected to the fixed mount at a pivot connection;
a mold connected to the pivot arm of the tool body, the mold being shaped to be placed over a fastener connected to a surface;
a resin injection passage extending through the tool body and connected to the mold, wherein a curable material selectively flows through the resin injection passage into the mold, and
a load cell connected to the fixed mount, the load cell is a sensor operably connected to the pivot arm that senses movement of the pivot arm about the pivot connection.

2. The fastener sealing tool of claim 1, wherein the load cell sends a signal to a controller that corresponds to the amount of movement of the pivot arm about the pivot connection with the fixed mount.

3. The fastener sealing tool of claim 2, wherein the signal causes the controller to stop the flow of the curable material to the mold and generate an alert.

4. The fastener sealing tool of claim 1, wherein the load cell is a button that contacts and is pressed by the pivot arm, wherein movement of the pivot arm away from the load cell causes the button to become undepressed.

5. The fastener sealing tool of claim 1, further comprising:
a resin supply tank connected to the fixed mount;
a valve connected to the fixed mount and the resin supply tank;
a supply line extending between the mold and the valve for flowing resin between the valve and the mold.

6. The fastener sealing tool of claim 5 further comprising:
a resin cartridge pre-loaded with curable material is loaded into the resin supply tank;
a plunger in the resin cartridge that moves longitudinally along the length of the resin cartridge to apply pressure to the curable material in the resin cartridge.

7. The fastener sealing tool of claim 6 further comprising:
a pressure booster connected to an air supply inlet on the resin supply tank, and
wherein the pressure booster provides pressurized air to the plunger, and the plunger applies a force on the curable material in the resin cartridge.

8. The fastener sealing tool of claim 1, further comprising:
a resin supply tank connected to the fixed mount for supplying the curable material to the mold;
a valve connected to the fixed mount for controlling the flow of curable material from the resin supply tank to the resin injection passage, wherein the valve comprises:
a spool that is connected to a plunger;
an air inlet open port that applies air above the plunger to move the spool to allow the curable material to flow through the valve from a resin inlet of the valve to a resin outlet of the valve;
an air inlet close port that introduces air to a region in the valve that applies pressure to the plunger to move the spool from the open position to the closed position,
wherein the resin outlet of the valve connects to a supply line extending between the valve and the resin injection passage for flowing resin between the valve and the mold.

9. The fastener sealing tool of claim 1, wherein the mold is not translucent.

10. The fastener sealing tool of claim 1, wherein the curable material is a polysulfide sealant.

11. The fastener sealing tool of claim 1, further comprising:
wherein the mold is a translucent mold and the curable material is an ultraviolet light curable material, and
an ultraviolet light source connected to the tool body and configured to project an ultraviolet light through the translucent mold, wherein the ultraviolet light has a wavelength suitable for curing the ultraviolet light curable material after the ultraviolet light passes through the translucent mold.

12. A fastener sealing tool comprising:
a tool body having a fixed mount and a pivot arm pivotally connected to the fixed mount at a pivot connection;
a mold connected to the pivot arm of the tool body, the mold being shaped to be placed over a fastener connected to a surface;
a resin injection passage extending through the tool body and connected to the mold, wherein a curable material selectively flows through the resin injection passage into the mold, and
a load cell connected to the fixed mount, the load cell is a sensor operably connected to the pivot arm that senses movement of the pivot arm about the pivot connection, wherein the load cell sends a signal to a controller that corresponds to the amount of movement of the pivot arm about the pivot connection with the fixed mount and the signal causes the controller to stop the flow of the curable material to the mold and generate an alert.

13. The fastener sealing tool of claim 12, wherein the load cell is a button that contacts and is pressed by the pivot arm, wherein movement of the pivot arm away from the load cell causes the button to become undepressed.

14. The fastener sealing tool of claim 12, further comprising:
a resin supply tank connected to the fixed mount;
a valve connected to the fixed mount and the resin supply tank;
a supply line extending between the mold and the valve for flowing resin between the valve and the mold.

15. The fastener sealing tool of claim 14, further comprising:
a pressure booster connected to an air supply inlet on the resin supply tank, and
wherein the pressure booster provides pressurized air to the plunger, and the plunger applies a force on the curable material in the resin cartridge.

16. The fastener sealing tool of claim 14, further comprising:
a resin cartridge pre-loaded with curable material is loaded into the resin supply tank;
a plunger in the resin cartridge that moves longitudinally along the length of the resin cartridge to apply pressure to the curable material in the resin cartridge.

17. The fastener sealing tool of claim 14, further comprising:
a resin supply tank connected to the fixed mount for supplying the curable material to the mold;
a valve connected to the fixed mount for controlling the flow of curable material from the resin supply tank to the resin injection passage, wherein the valve comprises:
a spool that is connected to a plunger;
an air inlet open port that applies air above the plunger to move the spool to allow the curable material to flow through the valve from a resin inlet of the valve to a resin outlet of the valve;
an air inlet close port that introduces air to a region in the valve that applies pressure to the plunger to move the spool from the open position to the closed position,
wherein the resin outlet of the valve connects to a supply line extending between the valve and the resin injection passage for flowing resin between the valve and the mold.

18. The fastener sealing tool of claim 12, wherein the mold is not translucent.

19. The fastener sealing tool of claim 12, wherein the curable material is a polysulfide sealant.

20. The fastener sealing tool of claim 12, further comprising:
wherein the mold is a translucent mold and the curable material is an ultraviolet light curable material, and
an ultraviolet light source connected to the tool body and configured to project an ultraviolet light through the translucent mold, wherein the ultraviolet light has a wavelength suitable for curing the ultraviolet light curable material after the ultraviolet light passes through the translucent mold.

21. A fastener sealing tool comprising:
a tool body having a fixed mount and a pivot arm pivotally connected to the fixed mount at a pivot connection;
a mold connected to the pivot arm of the tool body, the mold being shaped to be placed over a fastener connected to a surface;
a resin injection passage extending through the tool body and connected to the mold, wherein a curable material selectively flows through the resin injection passage into the mold,
a load cell connected to the fixed mount, the load cell is a sensor operably connected to the pivot arm that senses movement of the pivot arm about the pivot connection, and the sensor includes a button that contacts and is pressed by the pivot arm so that movement of the pivot arm away from the sensor causes the button to become undepressed, wherein the load cell sends a signal to a controller that corresponds to the amount of movement of the pivot arm about the pivot connection with the fixed mount and the signal causes the controller to stop the flow of the curable material to the mold and generate an alert;
a resin supply tank connected to the fixed mount;
a resin cartridge pre-loaded with curable material loaded into the resin supply tank,
a valve connected to the fixed mount and the resin supply tank for controlling the flow of curable material from the resin supply tank to the mold;
a supply line extending between the mold and the valve for flowing curable material between the valve and the mold, and
a plunger in the resin cartridge that moves longitudinally along the length of the resin cartridge to apply pressure to the curable material in the resin cartridge.

22. The fastener sealing tool of claim 21, further comprising:
a pressure booster connected to an air supply inlet on the resin supply tank, wherein the pressure booster provides pressurized air to the plunger and applies a force on the curable material in the resin cartridge.

23. The fastener sealing tool of claim 21, further comprising:
wherein the valve is connected to the fixed mount and the resin supply tank, wherein the valve further comprises:
a spool that is connected to a plunger;
an air inlet open port that applies air above the plunger to move the spool to allow the curable material to flow through the valve from a resin inlet of the valve to a resin outlet of the valve;
an air inlet close port that introduces air to a region in the valve that applies pressure to the plunger to move the spool from the open position to the closed position,
wherein the resin outlet of the valve connects to a supply line extending between the mold and the valve for flowing resin between the valve and the mold.

24. The fastener sealing tool of claim 21, wherein the mold is not translucent.

25. The fastener sealing tool of claim 21, wherein the curable material is a polysulfide sealant.

26. The fastener sealing tool of claim 21, further comprising:
wherein the mold is a translucent mold and the curable material is an ultraviolet light curable material, and
an ultraviolet light source connected to the tool body and configured to project an ultraviolet light through the translucent mold, wherein the ultraviolet light has a wavelength suitable for curing the ultraviolet light curable material after the ultraviolet light passes through the translucent mold.
